(19) United States
(12) Patent Application Publication
(10) Pub. No.: US 2010/0164832 A1
(43) Pub. Date: Jul. 1, 2010

(54) ANTENNA DEVICE

(75) Inventors: Tiao-Hsing Tsai, Yunghe City (TW); Chih-Wei Liao, Su-ao Township (TW); Chao-Hsu Wu, Lujhu Township (TW); Chi-Yin Fang, Pingtung City (TW); Yuan-Chang Chao, Dayuan Township (TW)

Correspondence Address: HAMMER & ASSOCIATES, P.C., 3125 SPRINGBANK LANE, SUITE G, CHARLOTTE, NC, 28226, US

(73) Assignee: Quanta Computer Inc.

(21) Appl. No.: 12/430,953

(22) Filed: Apr. 28, 2009

(30) Foreign Application Priority Data
Dec. 31, 2008 (TW) 097151670

(51) Int. Cl. H01Q 21/00; H01Q 1/48; H01Q 1/36

(52) U.S. Cl. 343/893; 343/846; 343/700 MS

(57) ABSTRACT

An antenna device includes a grounding element and an antenna. The antenna includes a feeding element, first and second radiating elements, and a parasitic element. The first radiating element is coupled to the grounding element. The second radiating element is coupled to the feeding element, is disposed proximate to the first radiating element, and cooperates with the grounding element and the first radiating element to define an area thereamong. The parasitic element is disposed in the area and extends from the grounding element.

### CROSS-REFERENCE TO RELATED APPLICATION

This application claims priority of Taiwanese Application No. 097151670, filed on Dec. 31, 2008.

### BACKGROUND OF THE INVENTION

1. Field of the Invention

This invention relates to an antenna device, more particularly to an antenna device that is suitable for wireless wide area network (WWAN), wireless local area network (WLAN), and wireless personal area network (WPAN) applications.

2. Description of the Related Art

A conventional antenna device for a notebook computer operates in wireless wide area network (WWAN) frequency ranges, i.e., from 824 to 960 MHz and from 1710 to 2170 MHz, wireless personal area network (WPAN) frequency ranges, i.e., from 2402 to 2480 MHz and from 3168 to 4752 MHz, and wireless local area network (WLAN) frequency ranges, i.e., from 2412 to 2462 MHz and from 4900 to 5875 MHz. The conventional antenna device, however, is bulky, and hence occupies a relatively large space in the notebook computer.

### SUMMARY OF THE INVENTION

Therefore, the object of the present invention is to provide an antenna device that is applicable to a wireless wide area network (WWAN), a wireless local area network (WLAN), and a wireless personal area network (WPAN), and that has a relatively small size.

According to the present invention, an antenna device comprises a grounding element and an antenna. The antenna includes a feeding element, first and second radiating elements, and a parasitic element. The feeding element is spaced apart from the grounding element. The first radiating element has a first end portion, which is coupled to the grounding element, and a second end portion. The second radiating element has a first end portion, which is coupled to the feeding element, and a second end portion, which is disposed proximate to the second end portion of the first radiating element. The second radiating element cooperates with the grounding element and the first radiating element to define an area thereamong. The parasitic element is disposed in the area and extends from the grounding element.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an antenna device according to this invention;

FIG. 2 is an exploded perspective view illustrating a dielectric substrate, a grounding element, and first, second, and third antennas of the preferred embodiment;

FIG. 3 is a perspective view illustrating a notebook computer in which the preferred embodiment is installed;

FIG. 4 is a schematic view illustrating dimensions, in millimeter, of first and second radiating elements of each of the first, second, and third antennas of the preferred embodiment;

FIG. 5 is a plot illustrating a voltage standing wave ratio (VSWR) of the third antenna of the preferred embodiment;

FIG. 6 are plots illustrating radiation patterns of the preferred embodiment on the x-y, z-x, and y-z planes when operated at 894 MHz;

FIG. 7 are plots illustrating radiation patterns of the preferred embodiment on the x-y, z-x, and y-z planes when operated at 1920 MHz;

FIG. 8 is a plot illustrating a VSWR of the second antenna of the preferred embodiment;

FIG. 9 are plots illustrating radiation patterns of the preferred embodiment on the x-y, z-x, and y-z planes when operated at 2442 MHz;

FIG. 10 are plots illustrating radiation patterns of the preferred embodiment on the x-y, z-x, and y-z planes when operated at 3960 MHz;

FIG. 11 is a plot illustrating a VSWR of the first antenna of the preferred embodiment;

FIG. 12 are plots illustrating radiation patterns of the preferred embodiment on the x-y, z-x, and y-z planes when operated at 2540 MHz; and

FIG. 13 are plots illustrating radiation patterns of the preferred embodiment on the x-y, z-x, and y-z planes when operated at 5470 MHz.

### DETAILED DESCRIPTION OF THE PREFERRED EMBODIMENT

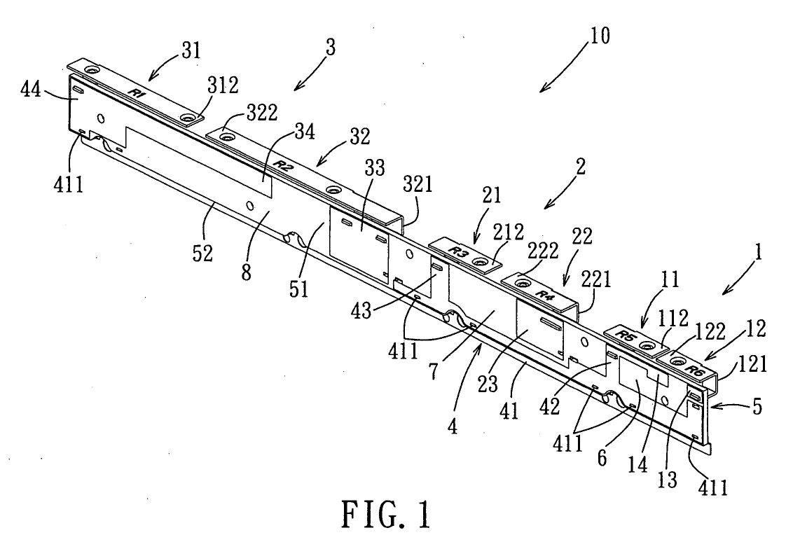

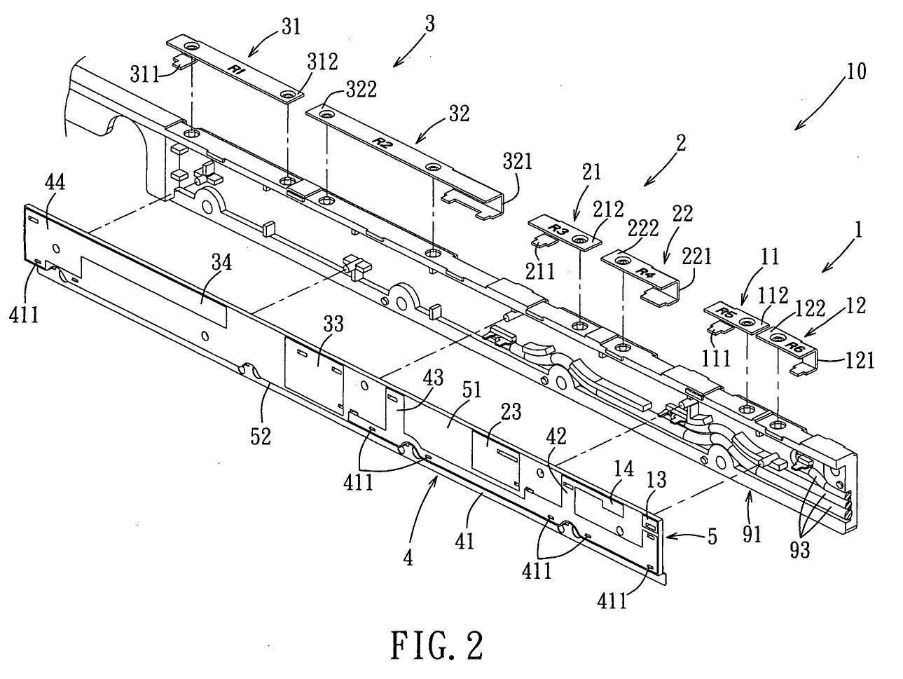

Referring to FIGS. 1 and 2, the preferred embodiment of an antenna device 10 according to this invention is shown to include a dielectric substrate 5, a grounding element 4, and first, second, and third antennas 1, 2, 3.

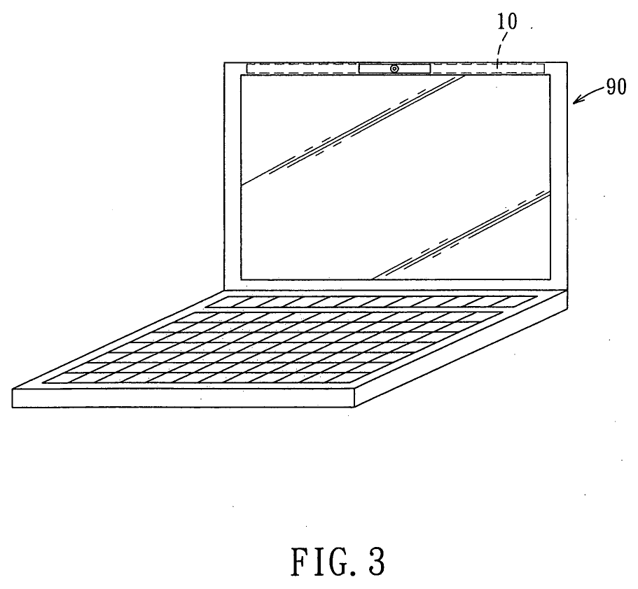

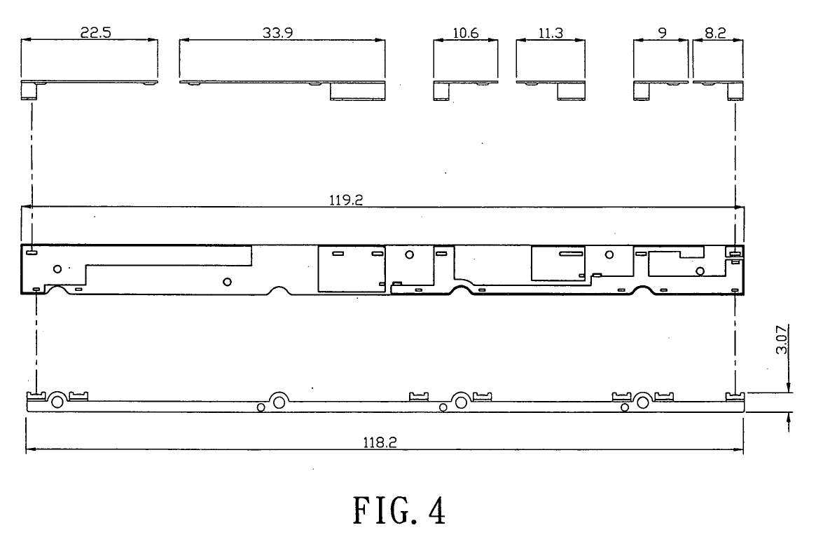

The antenna device 10 of this invention is mounted in a notebook computer 90, as illustrated in FIG. 3, has a relatively small size, as illustrated in FIG. 4, and operates in wireless wide area network (WWAN) frequency ranges, i.e., from 824 to 960 MHz and from 1710 to 2170 MHz, wireless personal area network (WPAN) frequency ranges, i.e., from 2402 to 2480 MHz and from 3168 to 4752 MHz, and wireless local area network (WLAN) frequency ranges, i.e., from 2412 to 2462 MHz and from 4900 to 5875 MHz.

The dielectric substrate 5 extends on a first plane.

The grounding element 4 includes first, second, third, and fourth segments 41, 42, 43, 44. The first segment 41 extends along an edge 52 of the dielectric substrate 5. Each of the second, third, and fourth segments 42, 43, 44 is formed on a surface 51 of the dielectric substrate 5. The first segment 41 is provided with a plurality of first extension 411, each of which extends through the dielectric substrate 5 and the second segment 42 and is connected to the second segment 42, a plurality of second extensions 411, each of which extends through the dielectric substrate 5 and the third segment 43 and is connected to the third segment 43, and a third extension 411, which extends through the dielectric substrate 5 and the fourth segment 44 and is connected to the fourth segment 44. Each of the second, third, and fourth segments 42, 43, 44 has a distal end distal from the first segment 41.

The first antenna 1 includes a feeding element 13, first and second radiating elements 11, 12, and a parasitic element 14.

The feeding element 13 of the first antenna 1 is formed on the surface 51 of the dielectric substrate 5, is spaced apart from the grounding element 4, and is connected to a first signal source (not shown) of the notebook computer 90 via a first feeding line 93.

The first radiating element 11 of the first antenna 1 has first and second end portions 111, 112. The first end portion 111 of the first radiating element 11 of the first antenna 1 extends through the dielectric substrate 5 and the distal end of the second segment 42 of the grounding element 4 and is connected to the distal end of the second segment 42 of the grounding element 4. In this embodiment, the first radiating element 11 of the first antenna 1 resonates at a low WLAN frequency in the high WLAN frequency range.

The second radiating element 12 of the first antenna 1 has first and second end portions 121, 122. The first end portion 121 of the second radiating element 12 of the first antenna 1 extends through the dielectric substrate 5 and the feeding element 13 of the first antenna 1 and is connected to the feeding element 13 of the first antenna 1. In this embodiment, the second radiating element 12 of the first antenna 1 resonates at a high WLAN frequency in the high WLAN frequency range.

In this embodiment, the first and second radiating elements 11, 12 of the first antenna 1 are substantially collinear. Moreover, in this embodiment, the second end portion 122 of the second radiating element 12 of the first antenna 1 is disposed proximate to the second end portion 112 of the first radiating element 11 of the first antenna 1. Further, in this embodiment, the second end portions 112, 122 of the first and second radiating elements 11, 12 of the first antenna 1 extend on a second plane transverse to the first plane.

The first and second segments 41, 42 of the grounding element 4 and the first and second radiating elements 11, 12 of the first antenna 1 cooperatively define a generally rectangular first area 6 thereamong.

The parasitic element 14 of the first antenna 1 is formed on the surface 51 of the dielectric substrate 5, is disposed in the first area 6, is generally L-shaped, extends from the distal end of the second segment 42 of the grounding element 4, and has a portion parallel to the second end portions 112, 122 of the first and second radiating elements 11, 12 of the first antenna 1. In this embodiment, the parasitic element 14 of the first antenna 1 resonates at a WLAN frequency in the low WLAN frequency range.

It is noted that the parasitic element 14 of the first antenna 1 provides an impedance bandwidth, which may be varied by simply adjusting an electromagnetic coupling between the parasitic element 14 of the first antenna 1 and the first and second radiating elements 11, 12 of the first antenna 1.

The second antenna 2 includes a feeding element 23 and first and second radiating elements 21, 22.

The feeding element 23 of the second antenna 2 is formed on the surface 51 of the dielectric substrate 5, is spaced apart from the grounding element 4, and is connected to a second signal source (not shown) of the notebook computer 90 via a second feeding line 93. The first radiating element 21 of the second antenna 2 has first and second end portions 211, 212. The first end portion 211 of the first radiating element 21 of the second antenna 2 extends through the dielectric substrate 5 and the distal end of the third segment 43 of the grounding element 4 and is connected to the distal end of the third segment 43 of the grounding element 4. In this embodiment, the first radiating element 21 of the second antenna 2 resonates at a WPAN frequency in the low WPAN frequency range.

The second radiating element 22 of the second antenna 2 has first and second end portions 221, 222. The first end portion 221 of the second radiating element 22 of the second antenna 2 extends through the dielectric substrate 5 and the feeding element 23 of the second antenna 2 and is connected to the feeding element 23 of the second antenna 2. In this embodiment, the second radiating element 22 of the second antenna 2 resonates at a WPAN frequency in the high WPAN frequency range.

In this embodiment, the first and second radiating elements 21, 22 of the second antenna 2 are substantially collinear. Moreover, in this embodiment, the second end portion 222 of the second radiating element 22 of the second antenna 2 is disposed proximate to the second end portion 212 of the first radiating element 21 of the second antenna 2. Further, in this embodiment, the second end portions 212, 222 of the first and second radiating elements 21, 22 of the second antenna 2 extend on the second plane.

The first and third segments 41, 43 of the grounding element 4 and the first and second radiating elements 21, 22 of the second antenna 2 cooperatively define a generally rectangular second area 7 thereamong.

The third antenna 3 includes a feeding element 33, first and second radiating elements 31, 32, and a parasitic element 34.

The feeding element 33 of the third antenna 3 is formed on the surface 51 of the dielectric substrate 5, is spaced apart from the grounding element 4, and is connected to a third signal source (not shown) of the notebook computer 90 via a third feeding line 93.

The first radiating element 31 of the third antenna 3 has first and second end portions 311, 312. The first end portion 311 of the first radiating element 31 of the third antenna 3 extends through the dielectric substrate 5 and the distal end of the fourth segment 44 of the grounding element 4 and is connected to the distal end of the fourth segment 44 of the grounding element 4. In this embodiment, the first radiating element 31 of the third antenna 3 resonates at a low WWAN frequency, i.e., at approximately 1800 MHz, in the high WWAN frequency range.

The second radiating element 32 of the third antenna 3 has first and second end portions 321, 322. The first end portion 321 of the second radiating element 32 of the third antenna 3 extends through the dielectric substrate 5 and the feeding element 33 of the third antenna 3 and is connected to the feeding element 33 of the third antenna 3. In this embodiment, the second radiating element 32 of the third antenna 3 resonates at a high WWAN frequency, i.e., at approximately 2100 MHz, in the high WWAN frequency range.

In this embodiment, the first and second radiating elements 31, 32 of the third antenna 3 are substantially collinear. Moreover, in this embodiment, the second end portion 322 of the second radiating element 32 of the third antenna 3 is disposed proximate to the second end portion 312 of the first radiating element 31 of the third antenna 3. Further, in this embodiment, the second end portions 312, 322 of the first and second radiating elements 31, 32 of the third antenna 3 extend on the second plane.

The first and fourth segments 41, 44 of the grounding element 4 and the first and second radiating elements 31, 32 of the third antenna 3 cooperatively define a generally rectangular third area 8 thereamong.

The parasitic element 34 of the third antenna 3 is formed on the surface 51 of the dielectric substrate 5, is disposed in the third area 8, is elongated, extends from the distal end of the fourth segment 44 of the grounding element 4, and is parallel to the second end portions 312, 322 of the first and second radiating elements 31, 32 of the third antenna 3. In this embodiment, the parasitic element 34 of the third antenna 3 resonates at a WWAN frequency in the low WWAN frequency range.

It is noted that the parasitic element 34 of the third antenna 3 provides an impedance bandwidth, which may be varied by simply adjusting an electromagnetic coupling between the parasitic element 34 of the third antenna 3 and the first and second radiating elements 31, 32 of the third antenna 3.

In this embodiment, the first and second radiating elements 11, 12, 21, 22, 31, 32 of the first, second, and third antennas 1, 2, 3 have different lengths. Moreover, in this embodiment, the sum of the lengths of the second end portions 112, 122 of the first and second radiating elements 11, 12 and a gap between the second end portions 112, 122 of the first and second radiating elements 11, 12, the sum of the lengths of the second end portions 212, 222 of the first and second radiating elements 21, 22 and a gap between the second end portions 212, 222 of the first and second radiating elements 21, 22, and the sum of the lengths of the second end portions 312, 322 of the first and second radiating elements 31, 32 and a gap between the second end portions 312, 322 of the first and second radiating elements 31, 32 are different.

It is noted that the first segment 41 of the grounding element 4, and the second end portions 112, 122, 212, 222, 312, 322 of the first and second radiating elements 11, 12, 21, 22, 31, 32 of the first, second and third antennas 1, 2, 3 are mounted on a frame 91 of the notebook computer 90.

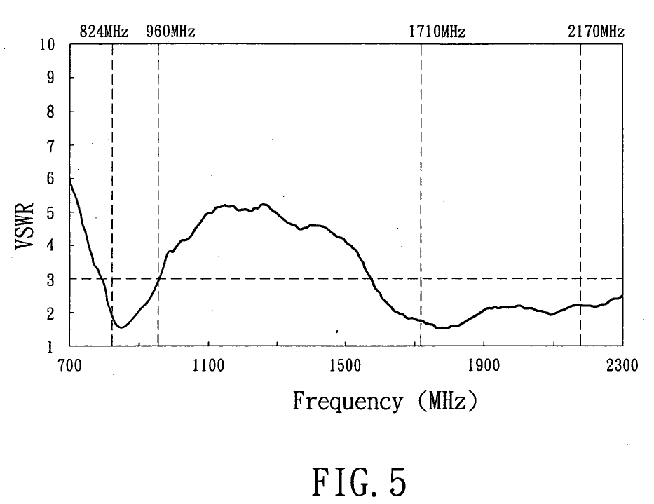

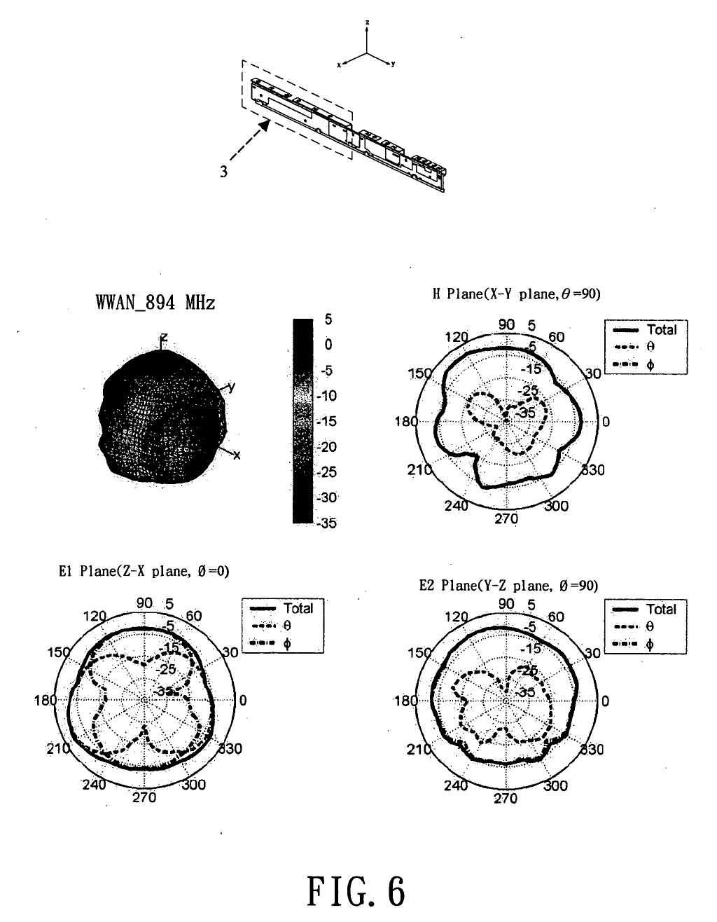

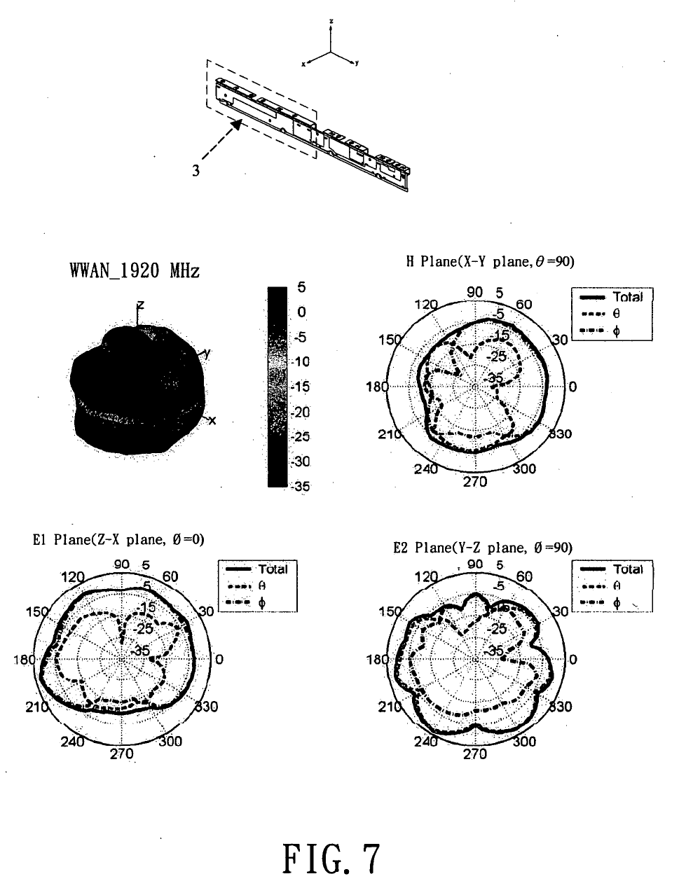

Experimental results, as illustrated in FIG. 5, show that the third antenna 3 achieves a voltage standing wave ratio (VSWR) of less than 3.0 when operated in the 824 to 960 MHz frequency range and the 1710 to 2170 MHz frequency range. Moreover, as illustrated in Table I below, the third antenna 3 achieves total radiation powers (TRP) efficiencies of at least −4.22 dB and at least 37.84% when operated at frequencies in the WWAN frequency ranges. Further, as illustrated in FIG. 6, the third antenna 3 has substantially omnidirectional radiation patterns on the x-y, z-x, and y-z planes when operated at 894 MHz. Still further, as illustrated in FIG. 7, the third antenna 3 has substantially omnidirectional radiation patterns on the x-y, z-x, and y-z planes when operated at 1920 MHz.

TABLE I

| Frequency (MHz) | Efficiency (dB) | Efficiency (%) |
|---|---|---|
| 824 | −2.93 | 50.88 |
| 836 | −2.79 | 52.66 |
| 849 | −2.61 | 54.87 |
| 869 | −2.85 | 51.85 |
| 880 | −3.15 | 48.37 |
| 894 | −2.90 | 51.26 |
| 900 | −2.96 | 50.54 |
| 915 | −3.15 | 48.45 |
| 925 | −3.33 | 46.47 |
| 940 | −3.56 | 44.07 |
| 960 | −4.22 | 37.84 |
| 1710 | −2.17 | 60.63 |
| 1750 | −1.84 | 65.47 |
| 1785 | −2.60 | 54.93 |
| 1805 | −3.08 | 49.21 |
| 1840 | −3.03 | 49.74 |
| 1850 | −3.00 | 50.17 |
| 1880 | −2.74 | 53.22 |
| 1910 | −2.24 | 59.71 |
| 1920 | −2.37 | 57.98 |
| 1930 | −2.43 | 57.20 |
| 1950 | −2.66 | 54.15 |
| 1960 | −2.87 | 51.67 |
| 1980 | −2.94 | 50.80 |
| 1990 | −3.03 | 49.79 |
| 2110 | −3.76 | 42.09 |
| 2140 | −3.66 | 43.00 |
| 2170 | −4.00 | 39.80 |

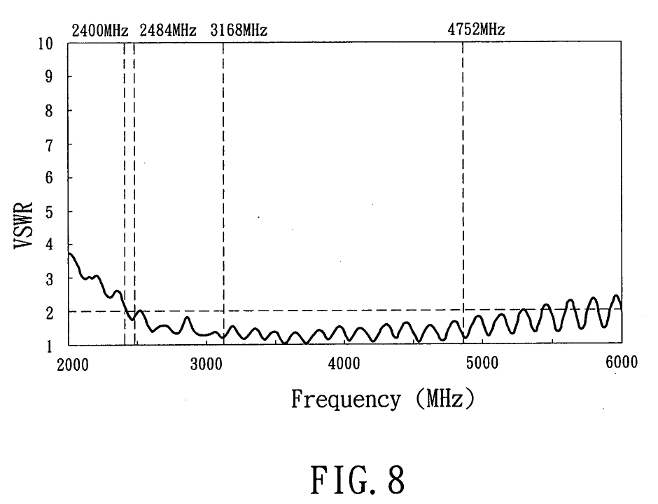

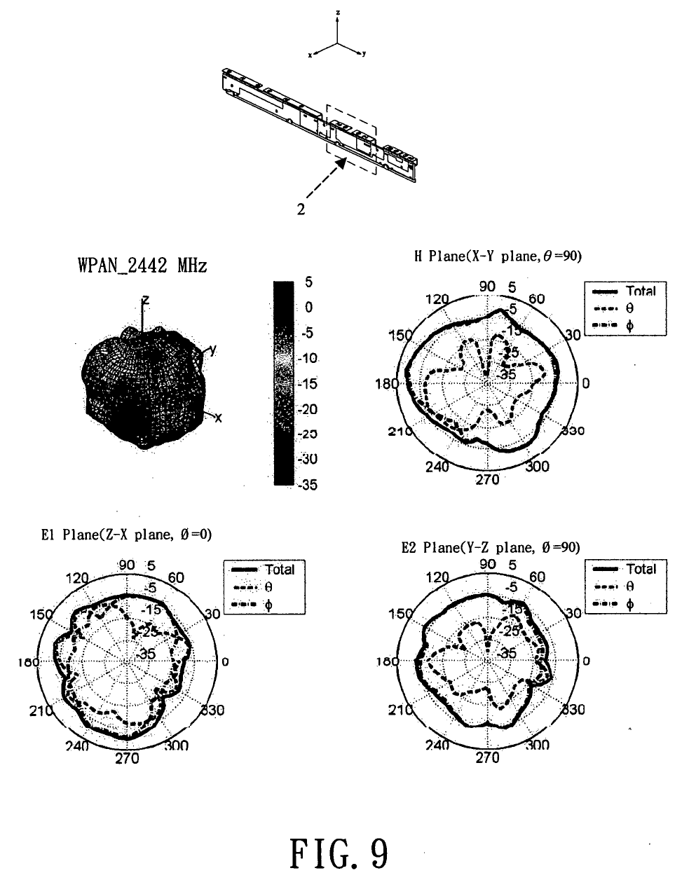

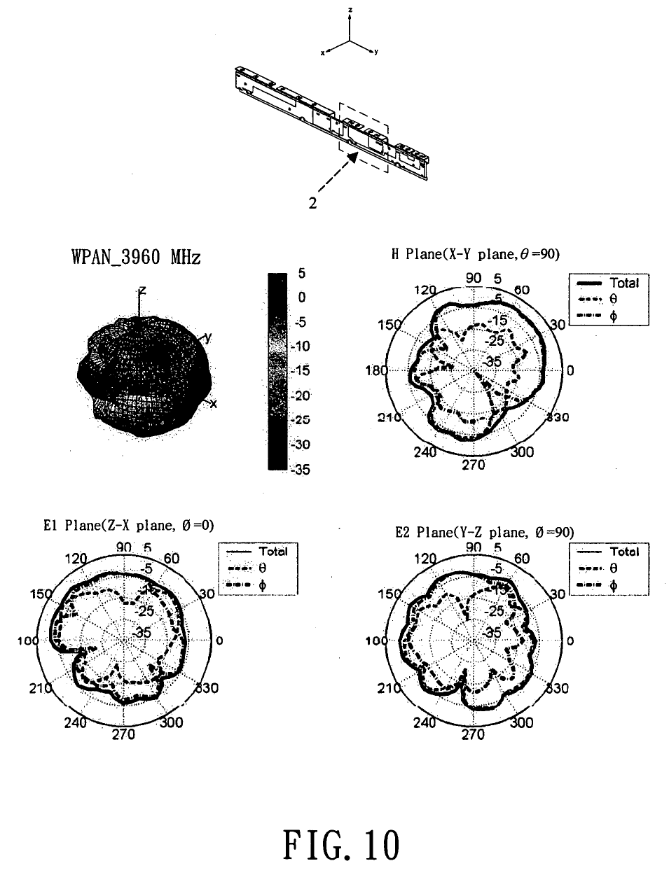

Furthermore, experimental results, as illustrated in FIG. 8, show that the second antenna 2 achieves a VSWR of less than 2.0 when operated in the 2400 to 2484 MHz frequency range and the 3168 to 4752 MHz frequency range. Moreover, as illustrated in Table II below, the second antenna 2 achieves total radiation powers (TRP) efficiencies of at least −4.64 dB and at least 44.70% when operated at frequencies in the WPAN frequency ranges. Further, as illustrated in FIG. 9, the second antenna 2 has substantially omnidirectional radiation patterns on the x-y, z-x, and y-z planes when operated at 2442 MHz. Still further, as illustrated in FIG. 10, the second antenna 2 has substantially omnidirectional radiation patterns on the x-y, z-x, and y-z planes when operated at 3960 MHz.

TABLE II

| Frequency (MHz) | Efficiency (dB) | Efficiency (%) |
|---|---|---|
| 2400 | −4.46 | 35.81 |
| 2442 | −4.52 | 35.29 |
| 2484 | −4.27 | 37.44 |
| 3168 | −4.48 | 35.65 |
| 3300 | −4.48 | 35.63 |
| 3432 | −4.64 | 34.32 |
| 3564 | −3.50 | 44.70 |
| 3696 | −3.59 | 43.78 |
| 3828 | −4.45 | 35.88 |
| 3960 | −4.10 | 38.90 |
| 4092 | −3.96 | 40.15 |
| 4224 | −4.06 | 39.29 |
| 4356 | −4.48 | 35.65 |
| 4488 | −4.24 | 37.66 |
| 4620 | −4.23 | 37.73 |
| 4752 | −4.54 | 35.14 |

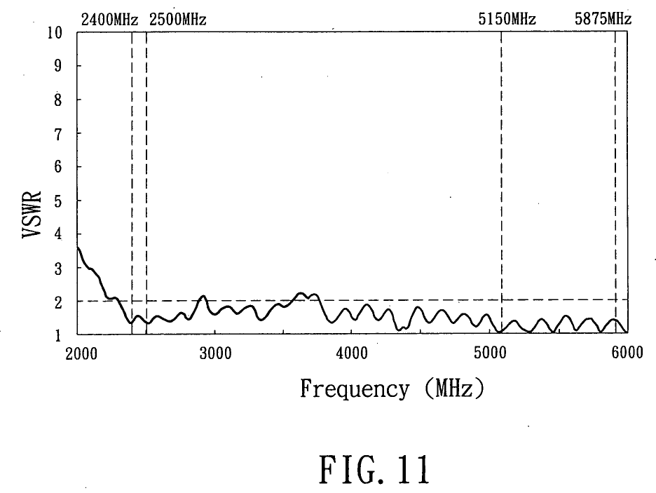

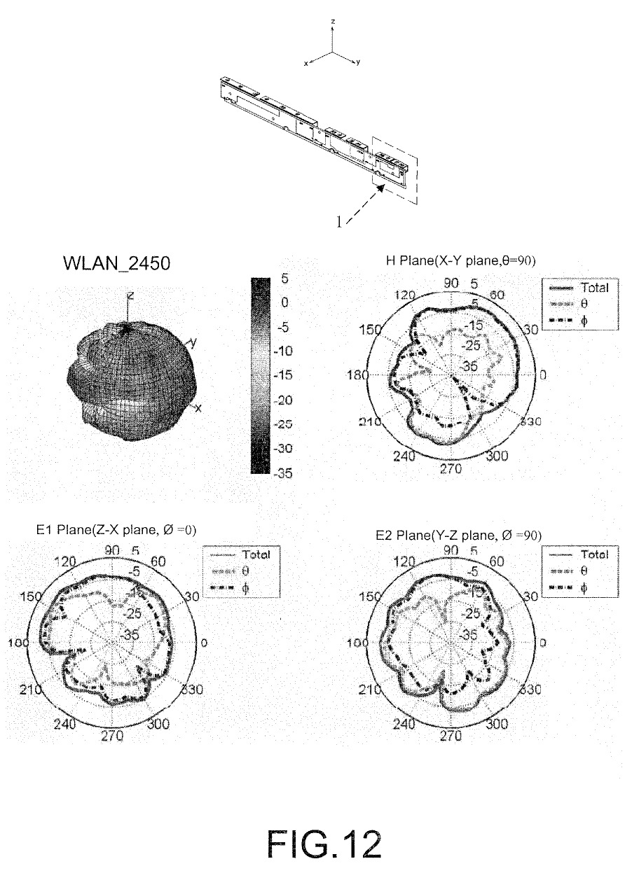

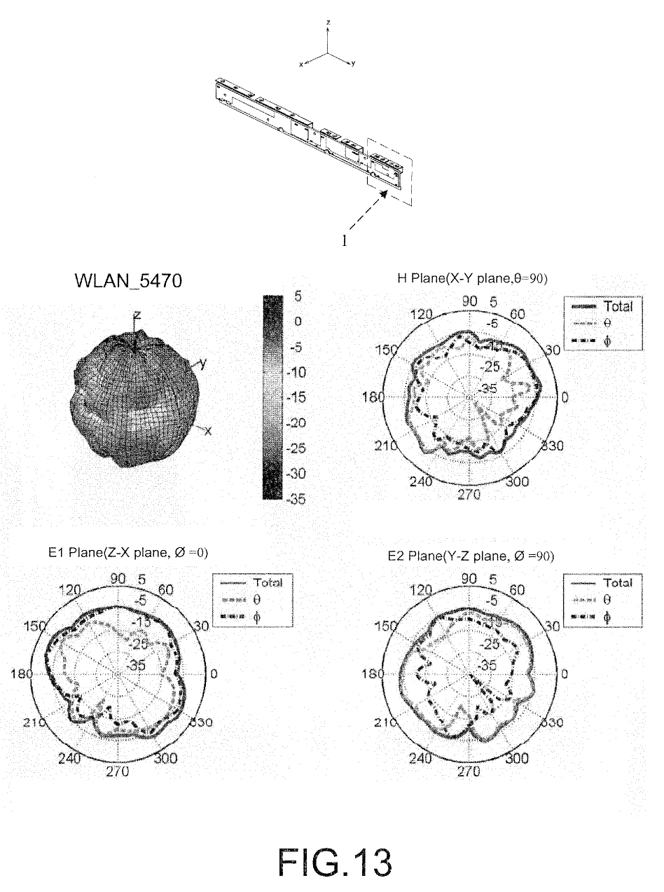

In addition, experimental results, as illustrated in FIG. 11, show that the first antenna 1 achieves a VSWR of less than 2.0 when operated in the 2400 to 2500 MHz frequency range and the 5150 to 5875 MHz frequency range. Moreover, as illustrated in Table III below, the first antenna 1 achieves total radiation powers (TRP) efficiencies of at least −4.95 dB and at least 32.01% when operated at frequencies in the WLAN frequency ranges. Further, as illustrated in FIG. 12, the first antenna 1 has substantially omnidirectional radiation patterns on the x-y, z-x, and y-z planes when operated at 2450 MHz. Still further, as illustrated in FIG. 13, the first antenna 1 has substantially omnidirectional radiation patterns on the x-y, z-x, and y-z planes when operated at 5470 MHz.

TABLE III

| Frequency (MHz) | Efficiency (dB) | Efficiency (%) |
|---|---|---|
| 2400 | −4.39 | 36.43 |
| 2450 | −4.56 | 35.03 |
| 2500 | −4.25 | 37.61 |
| 5150 | −3.41 | 45.62 |
| 5350 | −4.34 | 36.84 |
| 5470 | −4.41 | 36.22 |
| 5725 | −4.95 | 32.01 |
| 5875 | −4.47 | 35.77 |

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna device, comprising:
a grounding element; and
a first antenna including
a feeding element that is spaced apart from said grounding element,
a first radiating element that has a first end portion, which is coupled to said grounding element, and a second end portion,
a second radiating element that has a first end portion, which is coupled to said feeding element, and a second end portion, which is disposed proximate to said second end portion of said first radiating element, said second radiating element cooperating with said grounding element and said first radiating element to define a first area thereamong, and
a parasitic element that is disposed in said first area and that extends from said grounding element.

2. The antenna device as claimed in claim 1, further comprising a dielectric substrate having a surface, said feeding element and said parasitic element being formed on said surface of said dielectric substrate.

3. The antenna device as claimed in claim 2, wherein said grounding element includes a first segment, and a second segment, which is coupled to said first segment and has a distal end distal from said first segment, said first end portion of said first radiating element being coupled to said distal end of said second segment of said grounding element.

4. The antenna device as claimed in claim 3, wherein said dielectric substrate further has an edge, said first segment of said grounding element extending along said edge of said dielectric substrate.

5. The antenna device as claimed in claim 3, wherein said parasitic element extends from said second segment of said grounding element.

6. The antenna device as claimed in claim 1, wherein said first and second radiating elements are substantially collinear.

7. The antenna device as claimed in claim 1, wherein said parasitic element is generally L-shaped.

8. The antenna device as claimed in claim 1, wherein each of said first and second radiating elements has a portion, said parasitic element having a portion parallel to at least one of said portions of first and second radiating elements.

9. The antenna device as claimed in claim 1, further comprising a second antenna including
a feeding element that is spaced apart from said grounding element,
a first radiating element that has a first end portion, which is coupled to said grounding element, and a second end portion, and
a second radiating element that has a first end portion, which is coupled to said feeding element of said second antenna, and a second end portion, which is disposed proximate to said second end portion of said first radiating element of said second antenna, said second radiating element of said second antenna cooperating with said grounding element and said first radiating element of said second antenna to define a second area thereamong.

10. The antenna device as claimed in claim 9, further comprising a dielectric substrate having a surface, said feeding elements of said first and second antennas and said parasitic element of said first antenna being formed on said surface of said dielectric substrate.

11. The antenna device as claimed in claim 9, wherein said grounding element includes a first segment, and second and third segments, each of which is coupled to said first segment and has a distal end distal from said first segment, said first end portion of said first radiating element of each of said first and second antennas being coupled to said distal end of a respective one of said second and third segments of said grounding element.

12. The antenna device as claimed in claim 9, wherein said first and second radiating elements of said second antenna are substantially collinear.

13. The antenna device as claimed in claim 9, further comprising a third antenna including
a feeding element that is spaced apart from said grounding element,
a first radiating element that has a first end portion, which is coupled to said grounding element, and a second end portion,
a second radiating element that has a first end portion, which is coupled to said feeding element of said third antenna, and a second end portion, which is disposed proximate to said second end portion of said first radiating element of said third antenna, said second radiating element of said third antenna cooperating with said grounding element and said first radiating element of said third antenna to define a third area thereamong, and
a parasitic element that is disposed in said third area and that extends from said grounding element.

14. The antenna device as claimed in claim 13, further comprising a dielectric substrate having a surface, said feeding elements of said first, second, and third antennas and said parasitic elements of said first and third antennas being formed on said surface of said dielectric substrate.

15. The antenna device as claimed in claim 13, wherein said grounding element includes a first segment, and second, third, and fourth segments, each of which is coupled to said first segment and has a distal end distal from said first segment, said first end portion of said first radiating element of each of said first, second, and third antennas being coupled to said distal end of a respective one of said second, third, and fourth segments of said grounding element.

16. The antenna device as claimed in claim 15, wherein said parasitic element of said third antenna extends from said fourth segment of said grounding element.

17. The antenna device as claimed in claim 13, wherein said parasitic element of said third antenna is elongated.

18. The antenna device as claimed in claim 17, wherein each of said first and second radiating elements of said third antenna has a portion, said parasitic element of said third antenna being parallel to at least one of said portions of first and second radiating elements of said third antenna.
